(19) United States
(12) Patent Application Publication
(10) Pub. No.: US 2023/0116034 A1
(43) Pub. Date: Apr. 13, 2023

(54) Data driven reliability development for computing system

(71) Applicant: Jin Ming Wen, Lake Orion, MI (US)

(72) Inventor: Jin Ming Wen, Lake Orion, MI (US)

(21) Appl. No.: 17/486,835

(22) Filed: Sep. 27, 2021

(51) Int. Cl. G06F 11/00; G06F 11/07

(52) U.S. Cl. CPC G06F 11/008; G06F 11/0745; G06F 11/0781

(57) ABSTRACT

The present invention provides a explicitly defined method for implementing some of reliabilities for a computing system under development comprising FMEA, systematic error detection said method is based on the exclusive disclosure that is: a computing system functionalities can be fully represented by the data comprising Input Data, Middle Data and Output Data, in which the Output Data represent fully the system functionalities under the input data from the system black-box point of view, the Middle Data represent fully the middle functionalities that are transporting and transforming the Input Data to the Output Data. So, the development activities that are against the functionalities, such as FMEA, systematic error detection will be complete, consistent, accurate and efficient if they are applied only for the data.

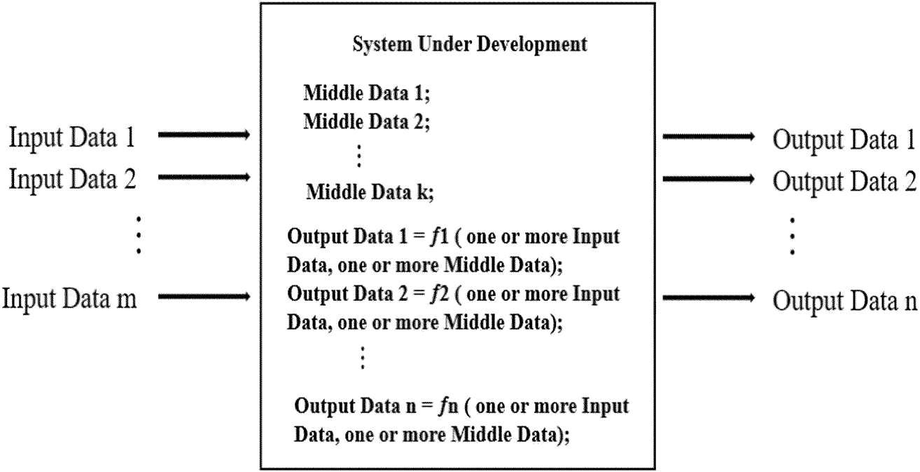

### COPYRIGHT NOTICE

This application includes material that is subject to copyright protection. The copyright owner has no objection to the facsimile reproduction by anyone of the patent document or patent disclosure, as it appears in the Patent and Trademark Office files or records, but otherwise reserves all copyright rights whatsoever.

### BACKGROUND OF THE INVENTION

### Field of the Invention

The disclosed embodiments are related to the reliability design methods for computing systems under development and in particular to the Failure Mode and Effect Analysis (FMEA), systematic error detection in the system under development, and computer implemented method to detect the Freedom From Interference (FFI) violations.

### Description of the Related Art

### FMEA

The commonly used FMEA method in automotive industry is specified in the “Potential Failure Mode and Effects Analysis (FMEA)” (ISBN: 978-1-60534-136-1), in which the Approach section specifies: “There is no single or unique process for FMEA development”. The similar one is the FMEA method from Quality-One International. Said FMEA methods don’t have the defined explicit and complete approach to do the FMEA, instead of having very generic processes, basically the FMEA needs to develop the system requirement and design specifications, then to develop the failure modes, failure causes and effects based on said specifications. Such development is totally based on the developers’ experience, and highly depended on the specifications which are prone to ambiguous, incomplete and inconsistent, so the result is not certain, and the development is not efficient.

The other commonly used FMEA method is to use the tool of APIS IQ-RM comprising:
Step 1: Develop system structure.
Step 2: Design system functions based on said system structure.
Step 3: Develop function nets based on said system functions.
Step 4: Identify potential failure modes for each said system function.
Step 5: Develop failure nets based on said failure modes and said function nets.
Step 6: Classify each failure mode in said failure nets that is comprises:
   classify each failure’s severity from 1 to 10, and
   classify each failure’s occurrence from 1 to 10, and
   classify each failure’s detection from 1 to 10.
Step 7: Multiply those 3 classification numbers to derive failure mode risk rating for each said failure mode, if the product result is higher, then the failure mode is riskier.
Step 8: Analyze failure mode’s effects to the functions based on the failure mode risk ratings, function nets and failure nets.

The issues for the method above are:

The critical steps in said FMEA are the development of system structure in the step 1 and system functions in the step 2, and there is not clearly defined explicit and complete approach to do so currently. If there is anything that is not accurate or not necessary in the development, then the derived activities from which will not be accurate or not necessary in the following steps.

The function nets in the step 3 and the failure nets in the step 5 will impact the effect analysis in the step 8, and there is not clearly defined explicit and complete approach to do those steps. If the nets are incorrect, then the effect analysis results are incorrect.

The failure mode classification definition in the step 6 is vague and it not standardized, and the classification activities are redundant in the safety system development.

### Error Detection

The commonly used error detection method in a computing system under development is based on the developers’ experience against the requirement and design specifications that are specified either using the text tools, such as IBM DOORS or MKS Integrity, or the notation tools, such as the SysML that includes 9 types of diagram, the issues of which are that there is neither the clearly defined explicit and complete approach to design the error detection mechanisms, nor is there the clearly defined explicit and complete method to fully cover all the errors in the system.

For the text specified specifications, the issues will include that the text specifications are prone to ambiguous and incomplete, and it is difficult to figure out the logic relationships in the specifications, whose consequence is that the error detection mechanisms may be inconsistent, incomplete and inaccurate, and the development is inefficient.

For the notation specified specifications, the issues include that it is difficult to fully specify the system functionalities, and it is difficult to use the notations in the entire development team, and it is inefficient to develop the error detection mechanisms based on all the diagrams used in the development.

### Freedom From Interference (FFI) Violation Detection

The commonly used Freedom From Interference (FFI) violation detection is done manually, such as reviewing, walking through, which is inefficient and prone to mistakes.

### BRIEF SUMMARY OF THE INVENTION

The present invention provides a method for implementing some of reliabilities for a computing system under development comprising FMEA, systematic error detection and Freedom From Interference (FFI) violation detection, said method is based on the exclusive disclosure that is: a computing system functionalities can be fully represented by the data comprising Input Data, Middle Data and Output Data, in which the Output Data represent fully the system functionalities under the input data from the system black-box point of view, the Middle Data represent fully the middle functionalities that are transporting and transforming the Input Data to the Output Data.

So, the development activities that are against the functionalities, such as FMEA, systematic error detection and freedom from interference violation detection, will be complete, consistent, accurate and efficient if they are applied only for only data.

### BRIEF DESCRIPTION OF THE DRAWING

The FIGURE is an illustration of some embodiments of the disclosure. The preceding and other objects, features, and advantages of the disclosure will be apparent from the following description of embodiments.

### DETAILED DESCRIPTION OF THE INVENTION

### Terminology

Reliability: it means that a product acts as implemented. Taking the famous “Hello World” software code as an example that is implemented to output the sentence of “Hello World”, if the code can always output the sentence: “Hello World”, then it can be said that the code is reliable because it does what is implemented. If there is a typo or mistake in the programming that wrote “World” as “Word”, which results in that the software code will output: “Hello Word”, and if the code can always output the sentence: “Hello Word”, then it can still be said that the code is reliable because it does what is implemented, as well.

Failure Mode, Error: in the disclosed embodiments, both Failure Mode and Error have the same meaning that the system does not act exactly as that said system is implemented.

Freedom From Interference (FFI): An aspect of functional safety is designing the system to isolate safety-critical functions from other functions and ensure they are free from interference, which is required by the ISO 26262.

Failure Mode an Effect Analysis (FMEA): is a method for identifying potential problems and their impact, which is required by the ISO 26262 in the system design phase.

Error characteristics in a computing system

For every computing system, it can be described using elements illustrated in the drawing consisting of a plurality of output data, a plurality of input data, a plurality of middle data and the calculations that are represented by formulas of f1, ..., fn, among which, one calculation is defined to derive each output data using one or more input data and one or more middle data. Wherein said calculations consist of not only the mathematic calculation but also any methods to derive the output data.

The middle data are defined to store and share middle calculating results to support the output data calculations, the calculations are defined to transform and transport the input data and middle data to the output data.

Taking the system as a black box, the output data represent the system external behaviors that are expected functionalities under the input data, and the output data depend totally on the input data, the middle data and the calculations, and anything else that is not in the calculations will not have any effect to the output data.

So, the development of the system reliability that is to prevent the system functionalities from systematic errors will be efficient if said development applies only on elements that have effects to the output data.

Said data and said calculations are mandatory in every computing system development because they are the system operation concept that establishes the relationships between the output data and input data, and they must be defined at the beginning of the development. If any said data or any said calculations is not defined explicitly and completely, then the system development will be infeasible.

In every computing system, all information in it is represented by a combination of binary “0” or “1” that represented by electronic signals. The binary combinations in the system represent either data or execution instructions, and the execution instructions are used to transmit and transform the data. In such system, systematic errors have only two types of error: Value Error and Time Error.

A value error is defined as that the binary combination has wrong value, which is caused by either binary combination transmitting or transforming, among which, the transmitting error is caused by transmitting device, consisting of that a binary combination is transmitted from an external peripheral device to the central processing unit, such as from an external flash memory to an internal RAM, or from one location to another location in the central processing unit, and some bits in the combination may be changed during the transmission, such as: a binary combination of “11101100” is transferred from location A to location B where the binary combination becomes “11101101” that may be caused either by transmitting equipment or by some external interference; the transforming error is caused by either wrong transforming instructions or wrong data that are used in the transformation.

In the system, although the transmitting error may happen to both data and execution instruction, the final effect will result in wrong data, because if it happens to a data, then the data will be wrong; if it happens to an execution instruction, and the execution instruction is used to transmit and transform some data, so the data will be wrong.

The binary combination transforming error is defined as that a wrong binary combination is derived from calculations operated by wrong instructions that may be changed during the transmission or during operation.

From analysis above, the effects of wrong calculations that are made of wrong execution instructions will result in wrong data.

A timing error is defined as that a required binary combination does not occur at required time. In a single central processing unit system, this type errors cannot be detected for the middle data and output data, because said data and execution instructions in the central processing unit are executed in serial sequence by an arithmetic logic unit (ALU) based on the system’s clock, instructions used to detect the errors and said data represented by binary combinations under detection run on a different piece of time in the arithmetic logic unit (ALU), so they don’t have common referenced time base to check any timing deviation.

From analysis above, in every computing system under development, it will be complete that the reliability development applies only on the data; and there are only two types of error to be prevent from: data value error and data timing error, among which, the data timing error for the output data and middle data in the single central processing unit system cannot be detected, so the data timing error applies only for the input data.

The disclosed embodiments describe some reliability development activities in a computing system under development, consisting of the Failure Mode and Effect Analysis (FMEA) that is required by the ISO 26262 in the system design, the systematic error detection that is mandatory for any system, and the Freedom From Interference (FFI) violation detection that is required by the ISO 26262 in the cases where there are coexisted components that have different Safety Integrity Level (SIL) classifications. The embodiments are based on the system operation concept described above which is driven by the data in the system under development, which is to apply the development activities only on the data consisting of input data, middle data and output data in the computing system under development.

### Application and Benefits

In every computing system development, a system operation concept must be established at the beginning, which is to establish the system realization logic consisting of defining the input data, middle data and output data, and defining the calculations for each output data using one or more input data and one or more middle data. The system architecture design including the reliability design will be done after the system operation concept is done.

In the disclosed embodiments, the FMEA will make use the system operation concept to find the failure modes, failure causes, effects analysis, and risks analysis.

For one of embodiments in the drawing, the system operation concept based on the output data, the input data and the middle data can be defined in detail using formulas below:

$$\text{Ouput Data 1 =} f \text{1} \left(\begin{matrix}\text{Input Data 11,} … \text{, Input Data 1i,} \\ \text{Middle Data 11,} … \text{, Middle 1j}\end{matrix}\right) ;$$

$$\text{Output Data 2 =} f \text{2} \left(\begin{matrix}\text{Input Data 21,} … \text{, Input Data 21,} \\ \text{Middle Data 21,} … \text{, Middle 2p}\end{matrix}\right) ;$$

Output Data n= fn (Input Data n1, ..., Input Data nq, Middle Data 1n, ..., Middle nr). Among the formulas above, m, n, k, i, j, l, p, q, r all are integers with the relationships: 1<= i, l, q <=m; 1<=j, p, r <= k; and all the input data groups consisting of the group of Input Data 11, ..., Input Data 1i, and the group of Input Data 21, ..., Input Data 2l, ..., and the group of Input Data n1, ..., Input Data nq are subsets of the input data group consisting of Input Data 1, ... Input Data m; and all the middle data groups consisting of the group of Middle Data 11, ..., Middle Data 1j, and the group of Middle Data 21, ..., Middle Data 2p, ..., and the group of Middle Data n1, ..., Middle Data nr are subsets of the middle data group consisting of Middle Data 1, ... Middle Data k.

One embodiment of doing the FMEA is to find all failure modes, all failure causes and failure effects, then to analyze risks based on the definitions above.

Wherein said all failure modes consist of the failure modes of said Output Data 1 consisting of the intrinsic failure modes of said Output Data 1 and the failure modes from each operated data in the calculation represented by the formula of f1 consisting of Input Data 11, ..., Input Data 1i, Middle Data 11, ..., Middle 1j, wherein said intrinsic failure modes of said Output Data 1 are defined as that said Output Data 1 does not behave as implemented; and using the same way to find the failure modes of the Output Data 2, ..., Output Data n.

Wherein said all failure causes consist of the failure causes for each failure mode of said Output Data 1 consisting of the intrinsic failure causes for each failure mode of said Output Data 1 and the failure causes for each failure mode of each operated data in the calculation represented by the formula of f1 consisting of Input Data 11, ..., Input Data 1i, Middle Data 11, ..., Middle 1j, wherein said intrinsic failure causes for each failure mode of said Output Data 1 are defined as the reasons that cause each failure mode of said Output Data 1 that does not behave said Output Data 1 as implemented; and using the same way to find the failure causes for each failure modes of the Output Data 2, ..., Output Data n.

Wherein said all failure effects consist of the failure effects for said Input Data 11 consisting of the intrinsic failure effects for said Input Data 11 and the failure effects for each derived data in the calculation represented by the formula of f1 consisting only of the Output Data 1, wherein said intrinsic failure effects for said Input Data 11 are defined as the failure effects from each failure mode of said Input Data 11; and using the same way to find the failure effects of the Input Data 21, ..., the Input Data 2l, the Input Data n1, ..., the Input Data nq, the Middle Data 21, ..., the Middle Data 2p, the Middle Data n1, ..., the Middle Data nr.

The failure effects from said Input Data 11 to said Output Data 1 are same as the failure modes from said Output Data 1 that are caused by the failure modes from one of the operated data in f1 that is said Input Data 11, which are same for all pairs between the Input Data and Output Data linked by their calculations, and all pairs between Middle Data and Output Data linked by their calculations.

Wherein said analyzing risks consists of assigning a severity level, a probability level and a controllability level for each failure mode in the system under development, wherein classifications of said severity, said probability and said controllability are carried over from the ISO 26262; prioritizing the risks according to the multiplication product of severity level, probability level and controllability level of each failure mode, the higher, the risker.

The FMEA method above can be done recursively to any data that need to be decomposed further into decompositions as the development progresses. For example, if the Middle Data 11 needs to be decomposed into such expression: Middle Data 11 = fm11 (Input Data 111, ... Input Data 11i, Middle Data 111, ..., Middle Data 11j), wherein said fm11 is the calculation to derive the Middle data 11, said input data group of Input Data 111, ..., Input Data 11i is a subset of input data group of Input Data 11, ..., Input Data 1i, said middle data group of Middle Data 111, ..., Middle Data 11j is a subset of middle data group of Middle Data 11, ..., Middle Data 1j. Then the FMEA method for the Middle Data 11 will be done by applying the FMEA processes above to the expression of Middle Data 11 = fm11 (Input Data 111, ... Input Data 11i, Middle Data 111, ..., Middle Data 11j).

The benefits of using the disclosed embodiments to do the FMEA consist of making use the definitions from the system operation concept, and all the FMEA activities consisting of finding all the failure modes, failure causes and failure effects apply only on the data; analyzing the risks is carried over from the ISO 26262 which is mandatory in the automotive safety system development that is clearly defined and standardized. The whole process of doing the FMEA above is clearly and completely defined and optimized, the result of which will be efficient, accurate, complete and consistent.

One embodiment of detecting systematic errors in a single central processing unit computing system under development based on the system operation concept above is to detect both value errors and timing errors from each input data consisting of Input Data 1, ..., Input Data m, and detecting the value errors from each middle data consisting of Middle Data 1, ..., Middle Data k, and from each output data consisting of Output Data 1, ..., Output Data n. Wherein said detecting input data value errors is to check each input data value against the check value embedded in said input data’s transmission protocol, such as CRC, checksum. Wherein said detecting input data timing errors is to check each input data time when it is received by the system against the time defined in said data’s transmission protocol. Wherein said detecting middle data and output data value errors is to check each said data value against the rationality and designed range.

The benefits of using the disclosed embodiments to detect the systematic errors in said system consist of making use the system operation concept; detection applies only on the data; the whole process of detecting the systematic errors above is clearly and completely defined, the result of which will be accurate, complete and consistent.

One embodiment of detecting the Freedom From Interference (FFI) violations in a computing system under development based on the system operation concept above is to define each said data and each said calculation with a specific Safety Integrity Level (SIL), then to check each calculation to against the Freedom From Interference (FFI) violation that is defined as said calculation operates any data that is defined with a higher Safety Integrity Level. For example, if the calculation represented by f1 is defined with SIL2, and the Middle Data j 1 is defined with the SIL4, then there is the Freedom From Interference (FFI) violation in the f1. The detection can be implemented in software tools, such as compiler, static check tool like QA-C, scripts.

The benefits of using the disclosed embodiments to detect the Freedom From Interference (FFI) violations in said system consist of making use the system operation concept; the detection criteria and procedures are clearly and completely defined that can be implemented using computer software, the result of which will be accurate, complete, automatic and consistent.

1. A Failure Modes and Effects Analysis (FMEA) method for a computing system under development consisting of:
a. defining a plurality of data consisting of 3 types of data:
one or more input data;
one or more middle data;
one or more output data; and
b. defining data calculations for each said output data using one or more said middle data and one or more said input data in said system;
c. finding all failure modes from each said data consisting of intrinsic failure modes from said data and all failure modes from operated data of said data, wherein said operated data comprise all the data used in said calculation to derive said data;
d. finding all failure causes for each said failure mode from each said data consisting of intrinsic failure causes for each said failure mode from said data and all failure causes for each said failure mode from operated data of said data, wherein said operated data comprise all the data used in said calculation to derive said data;
e. finding all failure effects for each said data consisting of failure effects for said data and all failure effects for derived data of said data, wherein said derived data comprise all the data that are derived from said data using said calculations.

2. (canceled)

3. The method of claim 1, wherein all said failure modes and all said failure causes and all said failure effects are defined as systematic errors consisting only of value errors and timing errors.

4. The method of claim 3, wherein said systematic error is defined as that said system does not act exactly as that said system is implemented.

5. (canceled)

6. The method of claim 3, wherein said data timing error is defined as that said data does not occur at the time when said data is required according to its implementation.

7. The method of claim 3, wherein said data value error is defined as that said data does not occur with said system implemented value.

8. (canceled)

9. (canceled)

10. (canceled)
